(19) United States
(12) Patent Application Publication
(10) Pub. No.: US 2026/0346554 A1
(43) Pub. Date: Nov. 5, 2026

(54) PULTRUSION PROCESSES FOR PRODUCING FIBER REINFORCED POLYURETHANE COMPOSITES AND POLYURETHANE-FORMING REACTION MIXTURES SUITABLE FOR USE IN SUCH PROCESSES

(71) Applicant: Covestro LLC, Pittsburgh, PA (US)

(72) Inventors: Christopher J. Marshall, Ben Avon, PA (US); Amanda Glaze, Eighty Four, PA (US)

(21) Appl. No.: 19/653,755

(22) Filed: Apr. 21, 2026

Related U.S. Application Data
(60) Provisional application No. 63/797,448, filed on Apr. 30, 2025.

(51) Int. Cl. B29C 70/52; B29C 70/00; B29K 75/00; B29K 105/00

(52) U.S. Cl. CPC B29C 70/521; B29C 70/003; B29C 70/528; B29K 2075/00; B29K 2105/0014

(57) ABSTRACT

Pultrusion processes for producing fiber reinforced polyurethane composites are described. The processes utilize a polyurethane-forming reaction mixture that includes, among other things, cyclic carbonate ester. Polyurethane-forming reaction mixtures suitable for use in such processes are also described.

### FIELD

This specification pertains generally to pultrusion processes for producing fiber reinforced polyurethane composites and to polyurethane-forming reaction mixtures suitable for use in such processes. The process can be operated at increased pultrusion line speed with one-sided injection of the reaction mixture into an impregnation chamber designed for tubular profiles, with peak exotherm and gelation of the reaction mixture occurring within a heated die, to provide a composite with a glossy, smooth appearance.

### BACKGROUND

Pultrusion is a manufacturing process for producing continuous lengths of fiber reinforced plastic structural shapes. Raw materials used in pultrusion processes include a liquid resin mixture (containing resin, fillers and specialized additives) and reinforcing fibers. The process involves pulling these raw materials, rather than pushing as is the case in extrusion, through a heated steel forming die using a continuous pulling device. The reinforcement materials are in continuous forms, such as rolls of fiberglass mat or doffs of fiberglass roving. The two ways to impregnate, or “wet out”, the glass are an open bath process and resin injection.

For polyurethanes, the resin injection process has been used. In the injection process, the reinforcement materials are passed through a small, closed box which is usually attached to the die or may be part of the die. The resin is injected under pressure through ports in the box to impregnate the reinforcement materials. Resin injection boxes are designed to minimize resin volume and resin residence time inside the box.

Line speed, which is the maximum rate at which a quality pultruded profile can be pulled, is a critical cost component for a pultrusion. The decision to use a polyurethane pultrusion system versus a competing material, such as a coated vinyl or unsaturated polyester, often depends upon which chemistry can produce a finished product that meets the requirements of the customer most efficiently. As a result, achieving higher line speeds is often critical.

One challenge associated with increasing pultrusion line speeds is maintaining gelation of the reaction mixture, defined by the peak exotherm, within the forming die. If gelation occurs outside of the die, adverse issues with part distortion and cracking can occur. Therefore, it is essential that cure of the polyurethane occurs within the die for the pultruded profile to maintain its geometric and structural integrity.

Another challenge, which is particularly related to pultruding large tubular profiles with complex glass builds, such as utility poles or sea pilings, is limiting injection of the resin to one side of an impregnation chamber to avoid random trapped air pockets from forming at the interface of two opposing liquid flow fronts, which could adversely impact the performance of the cured profile. To achieve a full and complete wet-out of the glass fibers with a one-sided injection of a tubular profile with a polyurethane system, the viscosity of the polyurethane-forming reaction mixture must be sufficiently low.

As a result, it would be desirable to provide a polyurethane pultrusion processes that can produce a composite with a glossy, smooth appearance while utilizing significantly increased line speeds, while using a polyurethane-forming reaction mixture of sufficiently low viscosity for use in a one-side injection process to produce large tubular profile composites. Furthermore, it would also be desirable to provide polyurethane-forming reaction mixtures suitable for use in such processes.

### SUMMARY

In certain respects, this specification is directed to processes for producing a fiber reinforced polyurethane composite. The processes comprise: (a) continuously pulling a roving or tow of continuous fiber reinforcing material through a resin impregnator; (b) contacting the continuous fiber reinforcing material with a polyurethane-forming reaction mixture in the resin impregnator such that at least partial wetting of the continuous fiber reinforcing material by the polyurethane-forming reaction mixture occurs in the resin impregnator; (c) directing the at least partially wetted fiber reinforcing material through a heating die that is heated to a reaction temperature sufficient to form the fiber reinforced polyurethane composite in the heating die; and (d) drawing the fiber reinforced polyurethane composite from the heating die. In these processes, the polyurethane-forming reaction mixture comprises: (i) a polyisocyanate; (ii) a natural oil polyol having a functionality of 1.0 to 1.8 and an OH number of 20 to 200 mg KOH/g; (iii) a polyol having functionality of greater than 1.8 to 10 and an OH number of 200 to 1200 mg KOH/g; (iv) a catalyst; and (v) a cyclic carbonate ester.

In other respects, this specification is directed to processes for producing a fiber reinforced polyurethane composite that comprise: (a) continuously pulling a roving or tow of continuous fiber reinforcing material through a resin injection chamber having a tubular cross-section; (b) contacting the continuous fiber reinforcing material with a polyurethane-forming reaction mixture in the resin injection chamber by injecting the polyurethane-forming reaction mixture from only one side of the resin injection chamber such that at least partial wetting of the continuous fiber reinforcing material by the polyurethane-forming reaction mixture occurs in the resin injection chamber; (c) directing the at least partially wetted fiber reinforcing material through a heating die that is heated to a reaction temperature sufficient to form the fiber reinforced polyurethane composite in the heating die; and (d) drawing the fiber reinforced polyurethane composite from the heating die. In these processes, the polyurethane-forming reaction mixture comprises: (i) a polyisocyanate; (ii) a polyol having functionality of greater than 1.8 to 10 and an OH number of 200 to 1200 mg KOH/g; (iii) a catalyst; and (iv) a cyclic carbonate ester.

This specification is also directed to polyurethane-forming reaction mixtures suitable for use in such processes and fiber reinforced polyurethane composites produced from the foregoing processes.

### DETAILED DESCRIPTION

Various implementations are described and illustrated in this specification to provide an overall understanding of the structure, function, properties, and use of the disclosed inventions. It is understood that the various implementations described and illustrated in this specification are non-limiting and non-exhaustive. Thus, the invention is not limited by the description of the various non-limiting and non-exhaustive implementations disclosed in this specification. The features and characteristics described in connection with various implementations may be combined with the features and characteristics of other implementations. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. § 112 and 35 U.S.C. § 132(a). The various implementations disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant(s) reserves the right to amend this specification to expressly recite any subject matter, or portion thereof, incorporated by reference herein.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 and 35 U.S.C. § 132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described implementations. Further, the use of a singular noun includes the plural, and the use of a plural noun includes the singular, unless the context of the usage requires otherwise.

As used herein, the term “functionality” refers to the average number of reactive hydroxyl groups, —OH, present per molecule of the —OH functional material that is being described. In the production of polyurethane foams, the hydroxyl groups react with isocyanate groups, —NCO, that are attached to the isocyanate compound. The term “hydroxyl number” or “OH number” refers to the number of reactive hydroxyl groups available for reaction and is expressed as the number of milligrams of potassium hydroxide equivalent to the hydroxyl content of one gram of the polyol, determined according to ASTM D4274-16. The term “equivalent weight” refers to the weight of a compound divided by its valence. For a polyol, the equivalent weight is the weight of the polyol that will combine with an isocyanate group and may be calculated by dividing the molecular weight of the polyol by its functionality. The equivalent weight of a polyol may also be calculated by dividing 56,100 by the hydroxyl number of the polyol-Equivalent Weight (g/eq)=(56.1×1000)/OH number.

Any number average and weight average, Mₙ and M_{w} value disclosed in this specification are values as determined by gel-permeation chromatography (GPC) using a method based on DIN 55672-1, employing chloroform as the eluent with a mixed bed column (Agilent PL Gel; SDVB; 3 micron Pore diameter: 1×Mixed-E+5 micron Pore diameter: 2× Mixed-D), refractive index (RI) detection and calibrated with polyethylene glycol as the standard.

As indicated, in some implementations, this specification relates to processes for producing a fiber reinforced polyurethane composite via pultrusion by: (a) continuously pulling a roving or tow of continuous fiber reinforcing material through a resin impregnator; (b) contacting the continuous fiber reinforcing material with a polyurethane-forming reaction mixture in the resin impregnator such that at least partial wetting of the continuous fiber reinforcing material by the polyurethane-forming reaction mixture occurs in the resin impregnator; (c) directing the at least partially wetted fiber reinforcing material through a heating die that is heated to a reaction temperature sufficient to form the fiber reinforced polyurethane composite in the heating die; and (d) drawing the fiber reinforced polyurethane composite from the heating die.

In certain implementations of such a process, a polyisocyanate and an isocyanate-reactive component, such as one or more polyols, are fed to a metering machine for delivery in a desired ratio to produce a polyurethane-forming reaction mixture that is fed to the resin impregnator. Suitable resin impregnators include resin baths and resin injection chambers (or injection dies) that impregnate fibers being pulled concurrently into the resin impregnator. In some implementations, the resin impregnator is a resin injection chamber in which the conditions in the resin injection chamber are such that little, or, in some cases, no polymerization of the polyurethane-forming reaction mixture occurs in the resin injection chamber. The resulting uncured composite is pulled through a heating die that is directly downstream of the resin impregnator, in which the heating die has a desired cross-section. The polyurethane-forming reaction mixture is shaped and cured in the heating die. The dynamic forces needed to pull the composite through the forming die are provided by a pulling machine which has gripping devices that contact the cured composite profile (or the glass fibers therein) and give the traction necessary to pull the composite profile through the die. The machine may also have a device that develops a force in the desired direction of pull that gives the impetus necessary to pull the composite profile continuously through the die. The resulting composite profile upon exiting the pulling machine may be cut to the desired length, for example, by an abrasive cut off saw.

A long fiber based reinforcing material provides mechanical strength to the pultruded composite and allows the transmission of the pulling force in the process. In some implementations, the fibers are at least long enough to pass though both the resin impregnator and heating die and attach to a source of tension. Suitable fibrous reinforcing materials for use in the processes of this specification include any fibrous material or materials that can provide long fibers capable of being at least partially wetted by the polyurethane-forming reaction mixture during impregnation. The fibrous reinforcing structure may be single strands, braided strands, woven or non-woven mat structures, combinations of these, or the like. Mats or veils made of long fibers may be used, in single ply or multi-ply structures. Suitable fibrous materials include, but are not limited to, glass fibers, glass mats, carbon fibers, polyester fibers, natural fibers, aramid fibers, nylon fibers, basalt fibers, and combinations thereof. The fibers and/or fibrous reinforcing structures may be formed continuously from one or more reels feeding into the pultrusion apparatus and attached to a source of pulling force at the outlet side of the heating die. The reinforcing fibers may optionally be pre-treated with sizing agents or adhesion promoters.

The weight percentage of the long fiber reinforcement in the pultruded composites described herein may vary, depending on the end use application intended for the composite articles. Reinforcement loadings may, for example, be from 30 to 95% by weight, from 40 to 90% by weight, from 60 to 90% by weight, or, in some cases, from 70 to 90% by weight, based on the weight of the final composite.

In some embodiments, a polyisocyanate component and an isocyanate-reactive component may be the only components that are fed into the resin impregnator in the pultrusion process. The polyisocyanate component and/or the isocyanate reactive component may, however, be premixed with catalyst and any optional additives.

In certain implementations, the pultrusion apparatus has at least one injection chamber and at least one heating (or curing) die. Because, in some implementations, little or no polymerization is to take place in the resin injection chamber, the curing die will often operate at a higher temperature than the resin injection chamber. The pultrusion apparatus may contain a plurality of curing dies, or zones. Different curing zones may be set at different temperatures, if desired, but, in many cases, all the zones of the curing die will be higher in temperature than the resin injection chamber. The pultrusion apparatus may contain a plurality of injection chambers, but in some cases, there is just one injection chamber, which is often situated immediately prior to the first curing die. As mentioned, the resin injection chamber is, in some implementations, set at a temperature that provides for substantially no reaction (polymerization) between the polyisocyanate component and the polyisocyanate-reactive component in the polyurethane-forming reaction mixture before the fibrous reinforcing structure, which has been at least partially impregnated with the polyurethane-forming reaction mixture, enters the first curing die. Moreover, in some implementations, the polyurethane-forming mixture is injected to the resin injection chamber by a so-called “one-sided injection” in which the polyurethane-forming reaction mixture is injected from only one side of an injection chamber that is designed for a tubular profile, such as a utility pole or sea piling.

The polyurethane-forming reaction mixtures used in the processes of this specification comprise an organic diisocyanate and/or polyisocyanate (collectively referred to as “polyisocyanate” in this specification). Any of the known organic polyisocyanates, modified polyisocyanates or isocyanate-terminated prepolymers made from any of the known organic isocyanates may be used. Suitable organic polyisocyanates include aromatic, aliphatic, and cycloaliphatic polyisocyanates and combinations thereof. In some implementations, the polyisocyanate has a viscosity at 25 °C of less than 1000 cps.

Examples of suitable polyisocyanates include those represented by the formula:

Q(NCO)ₙ

in which n is a number from 2 to 5, such as 2 to 3, and Q is an aliphatic hydrocarbon group containing 2 to 12, such as 4 to 6, carbon atoms, or a cycloaliphatic hydrocarbon group containing 4 to 6, such as 5 to 6, carbon atoms, an araliphatic hydrocarbon group containing 8 to 15, such as 8 to 13, carbon atoms, or an aromatic hydrocarbon group containing 6 to 15, such as 6 to 13, carbon atoms.

Specific examples of suitable polyisocyanates include ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; 1-isocyanato-3,3,5-trimethyl-5-isocyanatomethylcyclohexane (isophorone diisocyanate); 2,4- and 2,6-hexahydrotoluene diisocyanate and mixtures thereof; dicyclohexylmethane-4,4′-diisocyanate (hydrogenated MDI, or HMDI); 1,3- and 1,4-phenylene diisocyanate; 2,4- and 2,6-toluene diisocyanate and mixtures thereof (TDI); diphenylmethane-2,4′- and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MDI); norbornane diisocyanates; m- and p-isocyanatophenyl sulfonylisocyanates; perchlorinated aryl polyisocyanates; modified polyisocyanates containing carbodiimide groups; modified polyisocyanates containing urethane groups; modified polyisocyanates containing allophanate groups; modified polyisocyanates containing isocyanurate groups; modified polyisocyanates containing urea groups; polyisocyanates containing biuret groups; polyisocyanates obtained by telomerization reactions; polyisocyanates containing ester groups; reaction products of the above-mentioned isocyanates with acetals; and polyisocyanates containing polymeric fatty acid groups. It is also possible to use the isocyanate-containing distillation residues accumulating in the production of isocyanates on a commercial scale, optionally in solution in one or more of the polyisocyanates mentioned above. Mixtures of any two or more of the above-described polyisocyanates are of course also suitable.

In certain implementations, however, it may be desirable to employ an aliphatic polyisocyanate. In some implementations, for example, an aliphatic polyisocyanate is present in an amount of at least 50% by weight, such as at least 80% by weight, at least 90% by weight, or, in some cases at least 99% by weight or 100% by weight, based on the total weight of polyisocyanate.

Specific examples of suitable aliphatic polyisocyanates include ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; 1-isocyanato-3,3,5-trimethyl-5-isocyanatomethylcyclohexane (isophorone diisocyanate or IPDI); and dicyclohexylmethane-4,4′-diisocyanate (hydrogenated MDI, or HMDI), as well as mixtures of any two or more thereof.

Isocyanate-terminated prepolymers may also be employed. Prepolymers may be prepared by reacting an excess of organic polyisocyanate or mixtures thereof with a minor amount of an active hydrogen-containing compound as determined by the Zerewitinoff test, as described by Kohler in “Journal of the American Chemical Society,” 49, 3181(1927).

In some implementations, the polyisocyanate comprises a polyisocyanate having a number averaged isocyanate (NCO) functionality of from at least 2 to 6, such as 2 to 4 or, in some cases, 2 to 3. Moreover, in some implementations, the polyisocyanate component has a free isocyanate group content (NCO content) of 20% to 30% by weight, such as 23% to 30%, or, in some cases, 25% to 27% by weight. In some implementations, the polyisocyanate component may include a HMDI-terminated polyether prepolymer, such as those based on polypropylene ether glycol, that has a NCO content of 20% to 30% by weight, 23% to 30%, or, in some cases, 25% to 27% by weight.

In some implementations of the processes of this specification, the polyurethane-forming reaction mixture also comprises (1) a natural oil polyol having a functionality of 1.0 to 1.8 and an OH number of 20 to 200 mg KOH/g; (2) a polyol having functionality of greater than 1.8 to 10 and an OH number of 200 to 1200 mg KOH/g; (3) a catalyst; and (4) a cyclic carbonate ester. In certain implementations, components (1)-(4) are combined, in some cases with other components and additives, to form an isocyanate-reactive composition, that is then combined with the polyisocyanate to form the polyurethane-forming reaction mixture.

As indicated, in some cases, the polyurethane-forming reaction mixtures of this specification include a natural oil polyol. As used herein, “polyol” refers to an —OH functional material having a functionality of 1.0 or more. As used herein, a “natural oil polyol” is a polyol that is derived from an oil that occurs in nature, i.e., a natural oil, such as castor oil, peanut oil, soybean oil or canola oil. As such, these polyols are biomass derived, which means that they derive from a living or recently living organism, such as plants and animals, as opposed to a petroleum-based source. The hydroxyl groups present in a natural oil polyol can be naturally occurring or they can be introduced by, for example, modification of carbon-carbon double bonds present in the oil. Such modification can be accomplished by treatment of the oil with ozone, air oxidation, reaction of the oil with peroxides or hydroformylation.

As indicated, the natural oil polyol included in certain of the polyurethane-forming reaction mixtures of this specification having a functionality of 1.0 to 1.8 and an OH number of 20 to 200 mg KOH/g. In some implementations, the natural oil polyol has a functionality of 1.0 to 1.5, 1.1 to 1.4 or 1.2 to 1.4. In addition, in some implementations, the natural oil polyol has an OH number of 20 to 100 mg KOH/g, 50 to 100 mg KOH/g, or 60 to 80 mg KOH/g.

In some implementations, the natural oil polyol is present in an amount of 0.2 to 8% by weight, 1 to 8% by weight, 2 to 6% by weight, or 3 to 5% by weight, based on total weight of the polyurethane-forming reaction mixture.

The polyurethane-forming reaction mixtures of this specification also include a polyol having functionality of greater than 1.8 to 10, such as 1.9 to 10, and an OH number of 200 to 1200 mg KOH/g. Suitable polyols include, but are not limited to, polyether polyols and polyester polyols. In certain implementations, the polyol comprises a polyether polyol prepared by reacting an alkylene oxide, a halogen substituted or aromatic substituted alkylene oxide, or a mixture thereof, with an active hydrogen containing initiator compound.

In some embodiments, the polyol having a functionality of greater than 1.8 to 10 and an OH number of 200 to 1200 mg KOH/g comprises a polyol having a functionality of 2 to 6, such as 3 to 4.

In some cases, the polyol having functionality of greater than 1.8 to 10 and an OH number of 200 to 1200 mg KOH/g comprises a polyol blend, i.e., a mixture of two or more polyols.

For example, in some embodiments, the polyol blend comprises one or more rigid polyols. As will be appreciated, polyols that provide structural rigidity in the derived polymer are sometimes referred to in the art as “rigid polyols”. In certain implementations, the rigid polyols employed in the processes of this specification have a number averaged molecular weight of 80 Da to less than 1,500 Da, 80 to 750 Da, or, in some cases, 150 Da to 500 Da; and a functionality of 2 to 10, or, in some cases, 2 to 6, 2 to 5, 3 to 5, or 3 to 4. Such compounds include, for example, polyether or polyester polyols containing primary and/or secondary hydroxyl groups. In certain implementations, such rigid polyol(s) are present in the polyurethane-forming reaction mixture in an amount of at least 80% by weight, such as at least 90% by weight, or, in some cases, at least 95% by weight or at least 99% by weight, based on the total weight of polyols present in the polyurethane-forming reaction mixture.

In some implementations, the rigid polyol comprises at least one amine-initiated, sometimes aliphatic amine-initiated, polyether polyol having a functionality of greater than 3, such as greater than 3 to 5, in some cases 4 to 5, or 4, and a molecular weight of 150 to 410, such as 240 Da to 300 Da. As used herein, an “amine-initiated” polyether polyol refers to a polyether polyol in which the active hydrogen-containing initiator compound described above is predominantly one or more polyamines or aminoalcohols (or mixtures thereof), in which polyamine and/or aminoalcohol is present in an amount of more than 50% by weight, such as at least 80% by weight, at least 90% by weight, at least 95% by weight, at least 99% by weight, or 100% by weight, based on the total weight of active hydrogen-containing initiator employed to produce the polyether polyol.

Suitable amine-initiated polyols include, for example, the alkoxylation product of amines or aminoalcohols with at least two active hydrogen atoms with ethylene oxide and/or propylene oxide. Suitable aliphatic amine and aminoalcohol initiators include ammonia, ethylene diamine, hexamethylene diamine, methyl amine, diaminodiphenyl methane, aniline, ethanolamine, diethanolamine, N-methyl diethanolamine, tetrahydroxyl ethyl ethylenediamine, or a mixture of any two or more thereof. In some embodiments, the aliphatic amine-initiated polyol is the alkoxylation product of propylene oxide and ethylene diamine.

In some embodiments, the foregoing amine-initiated, such as aliphatic amine-initiated, polyether polyol is utilized in an amount of 10 to 50%, such as 20 to 40% or 30 to 40% by weight, based upon the total weight of polyol in the polyurethane-forming reaction mixture.

In some cases, the rigid polyol comprises a hydroxy-initiated polyether polyol. As used herein, a “hydroxy-initiated” polyether polyol refers to a polyether polyol in which the active hydrogen-containing initiator compound described above is predominantly one or more hydroxy-functional initiator compounds, in which hydroxy-functional initiator is present in an amount of more than 50% by weight, such as at least 80% by weight, at least 90% by weight, at least 95% by weight, at least 99% by weight, or 100% by weight, based on the total weight of active hydrogen-containing initiator employed to produce the polyether polyol. Suitable such polyether polyols include, for example alkoxylation products of hydroxy-functional starter molecules, such as ethylene glycol, propylene glycol, butanediol, hexanediol, trimethylolpropane, glycerin, pentaerythritol, sorbitol or mixtures of these and also other hydroxy-functional compounds (with the proviso that any low functionality starters, such as diols, are utilized in combination with higher functionality polyols, such as those having a hydroxyl functionality of 4 or more, in an amount such that the resulting polyether polyol has an average functionality of at least 3) with propylene oxide or butylene oxide.

In some embodiments, the foregoing rigid hydroxyl-initiated polyether polyol, or mixture of two or more thereof, is utilized in an amount of 50% to 90% by weight, such as 60 to 80% by weight or 60 to 70% by weight, based on total weight of polyol in the polyurethane-forming reaction mixture. In other embodiments, the foregoing rigid hydroxyl-initiated polyether polyol, or mixture of two or more thereof, is utilized in an amount of 50% to 90% by weight, such as 70 to 90% by weight or 80 to 90% by weight, based on total weight of polyol in the polyurethane-forming reaction mixture.

In some implementations, the foregoing rigid hydroxyl-initiated polyether polyol comprises a hydroxy-initiated polyether polyol having a functionality of at least 3 and less than 4, and a hydroxy-initiated polyether polyol having a functionality of at least 4, such as 4 to 5. In some of these implementations, the rigid hydroxyl-initiated polyether polyol having a functionality of at least 4 and the hydroxy-initiated polyether polyol having a functionality of at least 3 and less than 4 are present in a relative weight ratio of at least 1:1, such as 1:1 to 3:1, 1.5:1 to 2.5:1, or 1.7:1 to 2:1. In some embodiments, the rigid hydroxyl-initiated polyether polyol, or mixture of two or more thereof, consists essentially of hydroxyl-initiated polyether polyols having a functionality of 3, i.e., such hydroxy-functional polyether polyols are present in an amount of at least 95% by weight or at least 99% by weight, based on total weight of rigid polyol in the polyol blend.

In certain implementations, polyols referred to as chain extenders and/or crosslinkers may be included. Such polyols have molecular weights of 60 to less than 150 and isocyanate-reactive group functionalities of from 2 to 4, such as 2 to 3. However, it may be desirable to minimize the amount or avoid chain extenders and/or crosslinkers altogether.

Examples of chain-extenders/crosslinkers are simple glycols and triols, such as ethylene glycol, propylene glycol, dipropylene glycol, 1,4-butanediol, 1,3-butanediol, triethanolamine, triisopropanolamine, tripropylene glycol, diethylene glycol, triethylene glycol, as well as mixtures of any two or more thereof, as well as amines, such as diisopropanolamine, diethanolamine, 3,5-diethyl-2,4-diaminotoluene, 3,5-diethyl-2,6-diaminotoluene, and mixtures of any two or more thereof.

If desired, polyols that furnish softblock segments may be included. Such polyols often have a number average molecular weight of at least 1,500 Da, such as 1,750 Da to 8,000 Da, a number average equivalent weight of 400 Da to 4,000 Da, such as 750 Da to 2,500 Da, and a functionality of greater than 1.8, such as 1.8 to 10, such as 2 to 4. Such compounds include, for example, aliphatic polyether or aliphatic polyester polyols containing primary and/or secondary hydroxyl groups. In some implementations, such softblock polyols are present in an amount of 1 to 20% by weight, such as 5 to 15% by weight, based on the total weight of polyol in the polyurethane-forming reaction mixture.

As previously indicated, in the processes of this specification, the polyurethane-forming reaction mixture also comprises a catalyst. Catalyst(s) are often introduced by pre-mixing with the polyol(s). Suitable catalysts include, but are not limited to, tertiary amines, tertiary amine acid salts, organic metal salts, covalently bound organometallic compounds, and combinations thereof.

Examples of suitable tertiary amines include triethylenediamine, N,N-dimethyl cyclohexylamine, bis-(dimethylamino)-diethyl ether, N-ethyl morpholine, N,N,N′,N′,N″-pentamethyl diethylenetriamine, N,N-dimethyl aminopropylamine, N-benzyl dimethylamine, and aliphatic tertiary amine-containing amides of carboxylic acids, such as the amides of N,N-dimethyl aminopropylamine with stearic acid, oleic acid, hydroxystearic acid, and dihydroxylstearic acid.

Examples of suitable tertiary amine acid salt catalysts include those prepared by the at least partial neutralization of formic acid, acetic acid, 2-ethyl hexanoic acid, oleic acid, or oligomerized oleic acid with a tertiary amine such as triethylenediamine, triethanolamine, triisopropanolamine, N-methyl diethanolamine, N,N-dimethyl ethanolamine, mixtures thereof.

Examples of suitable organic metal salts include potassium 2-ethyl hexanoate, potassium oleate, potassium acetate, potassium hydroxide, bismuth octoate, zinc neodecanoate, dibutyltin dilaurate, dibutyltin diacetate, dibutyltin dioleate, among other organotin carboxylate catalysts. Other metal-based catalysts, which are suitable for use in the invention, include zinc carboxylates, such as zinc stearate and zinc neodecanoate, and bismuth carboxylates.

In some embodiments, however, the catalyst comprises a chelated organometallic/metalorganic catalyst. As used herein, the term “organometallic/metalorganic catalyst” means that the catalyst is an organometallic compound or a metalorganic compound. Thus, by “organometallic/metalorganic catalyst”, it is meant that an organometallic catalyst may be used in the absence of a metalorganic catalyst, a metalorganic catalyst may be used in the absence of an organometallic catalyst, or both an organometallic catalyst and a metalorganic catalyst may be used. As will be appreciated, an organometallic compound is a compound that contains at least one metal-carbon bond, i.e., a chemical bond directly between a metal and a carbon atom of an organic molecule. As will also be appreciated, a metalorganic compound is a metal-containing compound that lacks a direct metal-carbon bond but which contains one or more organic ligands.

In certain embodiments, the chelated organometallic/metalorganic catalyst comprises a ligand prepared from a functional molecule, such as a molecule having acid (such as carboxylic acid), amine, thiol, or hydroxyl functionality, among others. In certain implementations, however, the organometallic/metalorganic catalyst comprises a ligand prepared from a β-diketone, such as a β-diketone of the formula:

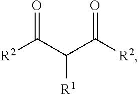

in which R¹ is hydrogen, an alkyl group having, for example, 1 to 10 carbon atoms, such as methyl, ethyl, propyl, isopropyl, butyl, isobutyl, t-butyl, pentyl, hexyl, cyclohexyl, heptyl, octyl, dodecanyl, octadecanyl, and the like, an aryl group, such as phenyl, cycloalkyl, or a hydroxyl, nitro, or cyano derivative thereof; and each R² is independently a hydrocarbon group, such as a saturated hydrocarbon group (such as methyl, ethyl, propyl, isopropyl, butyl, isobutyl, t-butyl, pentyl, hexyl, cyclohexyl, heptyl, octyl, dodecanyl, octadecanyl and the like), or an unsaturated hydrocarbon group (such as vinyl, an allyl, prenyl, crotyl, cyclopentadienyl, phenyl, tolyl, xylyl, a substituted aryl group and the like).

Specific examples of suitable β-diketones also include, but are not limited to, 2,4-pentanedione, 1,1,1-trifluoro-2,4-pentanedione, 1,1,1,5,5,5-hexafluoro-2,4-pentanedione, 2,4-hexanedione, 5-methyl-2,4-hexanedione, 5,5-dimethyl-2,4-hexanedione, 3-ethyl-2,4-pentanedione, 3-methyl-2,4-pentanedione, 2,4-octanedione, 2,4-decanedione, 2,2-dimethyl-3,5-nonanedione, 2,4-tridecanedione, 1-cyclohexyl-1,3-butanedione, 5,5-dimethyl-1,3-cyclohexanedione, 1,3-cyclohexanedione, 1-phenyl-1,3-butanedione, 1-phenyl-1,3-pentanedione, 1-(4-biphenyl)-1,3-butanedione, 3-benzyl-2,4-pentanedione, 1-phenyl-5,5-dimethyl-2,4-hexanedione, 1-phenyl-2-butyl-1,3-butanedione, and 1-phenyl-3,3-(2-methoxy-phenyl)-1,3-propanedione. Mixtures of any two or more thereof can, of course, also be used.

Any of a variety of organometallic/metalorganic catalysts can be used to form the chelated organometallic/metalorganic catalyst utilized in the processes of this specification. In certain embodiments, however, the organometallic/metalorganic catalyst comprises aluminum, barium, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, tin (II), tin (IV), titanium, vanadium, yttrium, zinc, zirconium, or a combination thereof. More particularly, in some cases, the organometallic/metalorganic catalyst comprises an organometallic/metalorganic catalyst having at least 3 ligand sites, such as cases in which the organometallic/metalorganic catalyst comprises both an organometallic catalyst having 2 ligand sites and an organometallic catalyst having 3 or more, in some cases 3, ligand sites. Even more particularly, in some implementations, the organometallic/metalorganic catalyst comprises a dialkylmetal dicarboxylate and a monoalkylmetal tricarboxylate. In such cases, the catalyst comprises: (i) a catalyst of the formula (1) and (ii) a catalyst of formula (2), in which formula (1) is

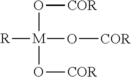

and formula (2) is

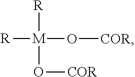

wherein M is tin (IV) and each R is independently a hydrocarbon or a substituted hydrocarbon radical, such as an alkyl, aralkyl, aryl, alkaryl, cycloalkyl, alkenyl, or cycloalkenyl radical.

Thus, in certain implementations, the organometallic/metalorganic catalyst comprises an organotin catalyst, such as an organotin (IV) catalyst. Specific examples of suitable organotin (IV) catalysts include, but are not limited to, various dialkyltin dicarboxylates, (R)₂Sn(OCOR)₂, and monoalkyltin tricarboxylates, RSn(OCOR)₃, in which each R is as described above with respect to formula (1) and formula (2). As a result, in certain embodiments, the organometallic catalyst comprises both a dialkyltin dicarboxylate and a monoalkyltin tricarboxylate. Specific examples of suitable dialkyltin dicarboxylates include, but are not limited to, dimethyltin dineodecanoate ((CH₃)₂Sn(OOCC₉H₁₉)₂), dibutyltin diacetate ((C₄H₉)₂Sn(OOCCH₃)₂), dibutyltin dilaurate ((C₄H₉)₂Sn(OOCC₁₁H₂₃)₂), dioctyltin diacetate ((C₈H₁₇)₂Sn(OOCCH₃)₂), dioctyltin di(2-ethylhexanoate) ((C₈H₁₇)₂Sn(OOCC—H₁₅)₂), dioctyltin dilaurate ((C₈H₁₇)₂Sn(OOCC₁₁H₂₃)₂) and dibutyltin dineodecanoate ((C₄H₉)₂Sn(OOCC₉H₁₉)₂). Specific examples of suitable monoalkyltin tricarboxylates includes, but are not limited to, monobutyltin trisoctoate and monobutyltin tris(2-ethylhexanoate). Mixtures of any two or more thereof can, of course, also be used.

More specifically, in some implementations, the organometallic/metalorganic catalyst comprises a dialkylmetal dicarboxylate, such as a dialkyltin dicarboxylate (such as any of those mentioned above), and a monalkylmetal tricarboxylate, such as a monoalkyltin tricarboxylate (such as any of those mentioned above), in which the monoalkylmetal tricarboxylate (such as monoalkyltin tricarboxylate) and the dialkylmetal dicarboxylate (such as dialkyltin dicarboxylate) are present in a relative ratio, by weight, of 1:5 to 5:1, such as 1:3 to 3:1, 1:2 to 2:1, or, in some cases 1:1.5 to 1.5:1.

In certain embodiments, the chelating agent, such as the β-diketone mentioned earlier, is present in an amount sufficient to bind with at least 80%, such as at least 90%, or, in some cases, is present in an amount sufficient to bind with 100% of the ligand sites of the organometallic/metalorganic catalysts present. Thus, in implementations where the organometallic/metalorganic catalyst comprises a dialkylmetal dicarboxylate, such as a dialkyltin dicarboxylate (such as any of those mentioned above), and a monalkylmetal tricarboxylate, such as a monoalkyltin tricarboxylate (such as any of those mentioned above), the chelating agent, such as the β-diketone mentioned earlier, is present in an amount sufficient to bind with at least 80%, such as at least 90%, or, in some cases, is present in an amount sufficient to bind with 100% of the total ligand sites available from the monoalkylmetal tricarboxylate (such as monoalkyltin tricarboxylate) and the dialkylmetal dicarboxylate (such as dialkyltin dicarboxylate).

In some implementations, catalyst is present in an amount of 0.1 to 3% by weight, such as 0.2 to 2.5% by weight, based on total weight of the polyurethane foam-forming reaction mixture.

As indicated earlier, the polyurethane-forming reaction mixture includes a cyclic carbonate ester. Suitable cyclic carbonate esters include, for example, butylene carbonate, ethylene carbonate, propylene carbonate, glycerol carbonate, or a mixture of any two or more thereof.

In some embodiments, the cyclic carbonate ester is present in an amount of 0.1 to 5% by weight, 1 to 4% by weight, or 1.5 to 3% by weight, based on total weight of the polyurethane-forming reaction mixture.

The polyurethane-forming reaction mixture may contain other optional additives, if desired. These optional additives are often included in a polyol-containing composition prior to processing, although it is also possible to premix all or any part of the optional additives package with the polyisocyanate component under the proviso that it does not cause the polyisocyanate to self-react or otherwise interfere with pultrusion processing of the reaction system. Examples of additional optional additives include particulate or short fiber fillers, internal mold release agents, fire retardants, smoke suppressants, dyes, pigments, antistatic agents, antioxidants, UV stabilizers, minor amounts of viscosity reducing inert diluents, combinations of these, and any other known additives from the art. In some embodiments of the present invention, the additives or portions thereof may be provided to the fibers, such as by coating the fibers with the additive.

Suitable internal mold release agents include, for example, fatty amides such as erucamide or stearamide, fatty acids such a oleic acid, oleic acid amides, fatty esters such as LOXIOL G71 S inert polyester (from Henkel), carnuba wax, beeswax (natural esters), butyl stearate, octyl stearate, ethylene glycol monostearate, ethylene glycol distearate, glycerin di-oleate, glycerin tri-oleate, and esters of polycarboxylic acids with long chain aliphatic monovalent alcohols such as dioctyl sebacate, mixtures of (a) mixed esters of aliphatic polyols, dicarboxylic acids and long-chained aliphatic monocarboxylic acids, and (b) esters of the groups: (1) esters of dicarboxylic acids and long-chained aliphatic monofunctional alcohols, (2) esters of long-chained aliphatic monofunctional alcohols and long-chained aliphatic monofunctional carboxylic acids, (3) complete or partial esters of aliphatic polyols and long-chained aliphatic monocarboxylic acids, silicones such as TEGO IMR 412T silicone (from Goldschmidt), KEMESTER 5721 ester (a fatty acid ester product from Witco Corporation), fatty acid metal carboxylates such as zinc stearate and calcium stearate, waxes such as montan wax and chlorinated waxes, fluorine containing compounds such as polytetrafluoroethylene, fatty alkyl phosphates (both acidic and non acidic types such as ZELEC UN, ZELEC AN, ZELEC MR, ZELEC VM, ZELEC UN, ZELEC LA-1, and ZELEC LA-2 phosphates, which are all commercially available from Stepan Chemical Company), chlorinated-alkyl phosphates; hydrocarbon oils, combinations of these, and the like. Exemplary suitable internal mold release agents are TECHLUBE 550HB available from Technick Products and 1948MCH available from Axel Plastics.

Suitable fillers include, for example, aluminum trihydrate, antimony oxide, milled glass fibers, wollastonite, talc, mica, flaked glass, titanium dioxide, micronized polyethylene and combinations thereof.

Other optional additives for use in pultrusion processing of polyurethanes include moisture scavengers, such as molecular sieves; defoamers, such as polydimethylsiloxanes; coupling agents, such as the mono-oxirane or organo-amine functional trialkoxysilanes; combinations of these and the like. Fine particulate fillers, such as clays and fine silicas, are often used at thixotropic additives. Such particulate fillers may also serve as extenders to reduce resin usage.

Fire retardants are sometimes desirable as additives in pultruded composites.

The stoichiometry of mixing isocyanate-based polymer forming formulations, containing an organic polyisocyanate and a polyfunctional isocyanate reactive resin is often expressed by a quantity known in the art as the isocyanate index. The index of such a mixing activated formulation is simply the ratio of the total number of reactive isocyanate (—NCO) groups present to the total number of isocyanate-reactive groups (that can react with the isocyanate under the conditions employed in the process). This quantity is often multiplied by 100 and expressed as a percent. Suitable index values for the processes described in this specification include, for example, 90 to 120%, such as 105 to 115%.

It was surprisingly observed that the polyurethane-forming reaction mixtures described in this specification can be utilized in a polyurethane pultrusion processes that can produce a composite with a glossy, smooth appearance while utilizing significantly increased line speeds, in which the polyurethane-forming reaction mixture of sufficiently low viscosity for use in a one-side injection process to produce large tubular profile composites. In addition, it was discovered, surprisingly, that such polyurethane-forming reaction mixtures, which can utilize a synergistic combination of natural oil polyol and cyclic propylene carbonate, can also utilize significantly reduced amounts of internal mold release agent, which still exhibit adequate release of the composite from the heating die, which reduces the antagonistic effect of internal mold release agent on the heat-activated, delayed-action catalyst. This reduction in internal mold release agent enables the catalyst to drive a quicker snap cure so that gelation still occurs within the heating die, even at significantly faster pull rates.

In some cases, the pultrusion is performed by supplying the polyisocyanate and polyol(s) to a mix/metering machine for delivery in a desired ratio to a mixing apparatus, such as a static mixer, to produce the reaction mixture. The reaction mixture is supplied to a resin injection chamber where it can be used to impregnate fibers being pulled concurrently into the resin injection chamber. The resulting uncured composite is pulled through a zoned curing die, attached directly to the resin injection chamber, having a desired cross-section where it is shaped and cured. In some implementations, the resin injection chamber has a tubular cross-section and the polyurethane-forming reaction mixture is injected from only one side of the resin injection chamber. The curing die may have, for example, two to three heated zones equipped with electrical heating coils individually controlled to maintain the desired temperatures. The entrance to the die is sometimes cooled. The temperature at the hottest zone sometimes ranges from 300 °F to 450 °F, such as 320° to 350 °F. The dynamic forces needed to pull the composite through the forming die are supplied by the pulling machine. This machine typically has gripping devices that contact the cured composite profile (or the glass fibers therein) and give the traction necessary to pull the composite profile through the die. The machine also has a device that develops a force in the desired direction of pull that gives the impetus necessary to pull the composite profile continuously through the die. The resulting composite upon exiting the pulling machine may be cut to the desired length, such as by an abrasive cut off saw.

Various aspects of the subject matter described herein are set out in the following numbered paragraphs:
Paragraph 1. A process for producing a fiber reinforced polyurethane composite, comprising: (a) continuously pulling a roving or tow of continuous fiber reinforcing material through a resin injection chamber; (b) contacting the continuous fiber reinforcing material with a polyurethane-forming reaction mixture in the resin injection chamber such that at least partial wetting of the continuous fiber reinforcing material by the polyurethane-forming reaction mixture occurs in the resin injection chamber; (c) directing the at least partially wetted fiber reinforcing material through a heating die that is heated to a reaction temperature to sufficient to form the fiber reinforced polyurethane composite in the heating die; and (d) drawing the fiber reinforced polyurethane composite from the heating die, wherein the polyurethane-forming reaction mixture comprises: (i) a polyisocyanate; (ii) a natural oil polyol having a functionality of 1.0 to 1.8 and an OH number of 20 to 200 mg KOH/g; (iii) a polyol having functionality of greater than 1.8 to 10 and an OH number of 200 to 1200 mg KOH/g; (iv) a catalyst; and (v) a cyclic carbonate ester.
Paragraph 2. The process of paragraph 1, wherein the resin impregnator is a resin bath or a resin injection chamber.
Paragraph 3. The process of paragraph 1 or paragraph 2, wherein the conditions in the resin impregnator are such that little or no polymerization of the polyurethane-forming reaction mixture occurs in the resin impregnator.
Paragraph 4. The process of one of paragraph 1 to paragraph 3, wherein the continuous fiber reinforcing material comprises glass fiber, glass mat, carbon fiber, polyester fiber, natural fiber, aramid fiber, nylon fiber, basalt fiber, or a combination of any two or more thereof.
Paragraph 5. The process of one of paragraph 1 to paragraph 4, wherein the continuous fiber reinforcing material is present in an amount of 30 to 95% by weight, 40 to 90% by weight, 60 to 90% by weight, or 70 to 90% by weight, based on the weight of the fiber reinforced polyurethane composite.
Paragraph 6. The process of one of paragraph 1 to paragraph 5, wherein a polyisocyanate component and an isocyanate-reactive component are the only components fed into the resin impregnator.
Paragraph 7. The process of one of paragraph 1 to paragraph 6, wherein the polyisocyanate comprises an aromatic polyisocyanate, an aliphatic polyisocyanate, a cycloaliphatic polyisocyanate, or a combination of any two or more thereof, such as where the polyisocyanate has a viscosity at 25 °C of less than 1000 cps.
Paragraph 8. The process of one of paragraph 1 to paragraph 7, wherein the polyisocyanate is represented by the formula:

Q(NCO)ₙ

in which n is a number from 2 to 5, such as 2 to 3, and Q is an aliphatic hydrocarbon group containing 2 to 12, such as 4 to 6, carbon atoms, a cycloaliphatic hydrocarbon group containing 4 to 6, such as 5 to 6, carbon atoms, an araliphatic hydrocarbon group containing 8 to 15, such as 8 to 13, carbon atoms, or an aromatic hydrocarbon group containing 6 to 15, such as 6 to 13, carbon atoms.
Paragraph 9. The process of one of paragraph 1 to paragraph 8, wherein the polyisocyanate comprises ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of thereof; 1-isocyanato-3,3,5-trimethyl-5-isocyanatomethylcyclohexane (isophorone diisocyanate); 2,4- and 2,6-hexahydrotoluene diisocyanate and mixtures thereof; dicyclohexylmethane-4,4′-diisocyanate (hydrogenated MDI, or HMDI); 1,3- and 1,4-phenylene diisocyanate; 2,4- and 2,6-toluene diisocyanate and mixtures thereof (TDI); diphenylmethane-2,4′- and/or -4,4′-diisocyanate (MDI); naphthylene-1,5-diisocyanate; triphenylmethane-4,4′,4″-triisocyanate; a polyphenyl-polymethylene-polyisocyanate; a norbornane diisocyanate; m- and p-isocyanatophenyl sulfonylisocyanates; perchlorinated aryl polyisocyanates; a modified polyisocyanate containing carbodiimide groups; a modified polyisocyanate containing urethane groups; a modified polyisocyanates containing allophanate groups; a modified polyisocyanate containing isocyanurate groups; a modified polyisocyanate containing urea groups; a polyisocyanate containing biuret groups; a polyisocyanate obtained by a telomerization reaction; a polyisocyanate containing ester groups; or a mixture of any two or more thereof.
Paragraph 10. The process of one of paragraph 1 to paragraph 9, wherein the polyisocyanate comprises an aliphatic polyisocyanate present in an amount of at least 50% by weight, such as at least 80% by weight, at least 90% by weight, or, in some cases at least 99% by weight or 100% by weight, based on the total weight of polyisocyanate, such as where the aliphatic polyisocyanate comprises ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures thereof; 1-isocyanato-3,3,5-trimethyl-5-isocyanatomethylcyclohexane (isophorone diisocyanate or IPDI); dicyclohexylmethane-4,4′-diisocyanate (hydrogenated MDI, or HMDI), or a mixture of any two or more thereof.
Paragraph 11. The process of one of paragraph 1 to paragraph 10, wherein the polyisocyanate component has a free isocyanate group content of 20% to 30% by weight, 23% to 30%, or 25% to 27% by weight, such as where the polyisocyanate comprises a HMDI-terminated polyether prepolymer, such as those based on polypropylene ether glycol, that has a NCO content of 20% to 30% by weight, 23% to 30%, or 25% to 27% by weight.
Paragraph 12. The process of one of paragraph 1 to paragraph 11, wherein the natural oil polyol has a functionality of 1.0 to 1.5, 1.1 to 1.4 or 1.2 to 1.4.
Paragraph 13. The process of one of paragraph 1 to paragraph 12, wherein the natural oil polyol has an OH number of 20 to 100 mg KOH/g, 50 to 100 mg KOH/g, or 60 to 80 mg KOH/g.
Paragraph 14. The process of one of paragraph 1 to paragraph 13, wherein the natural oil polyol is derived from castor oil, peanut oil, soybean oil, canola oil, or a mixture of any two or more thereof.
Paragraph 15. The process of one of paragraph 1 to paragraph 14, wherein the natural oil polyol is present in an amount of 0.2 to 8% by weight, 1 to 8% by weight, 2 to 6% by weight, or 3 to 5% by weight, based on total weight of the polyurethane-forming reaction mixture.
Paragraph 16. The process of one of paragraph 1 to paragraph 15, wherein the polyol having functionality of greater than 1.8 to 10 and an OH number of 200 to 1200 mg KOH/g comprises a polyether polyol, polyester polyol, or a mixture thereof.
Paragraph 17. The process of one of paragraph 1 to paragraph 16, wherein the polyol having a functionality of greater than 1.8 to 10 and an OH number of 200 to 1200 mg KOH/g has a functionality of 2 to 6 or 3 to 4.
Paragraph 18. The process of one of paragraph 1 to paragraph 17, wherein the polyol having functionality of greater than 1.8 to 10 and an OH number of 200 to 1200 mg KOH/g comprises a rigid polyol having a number averaged molecular weight of 80 Da to less than 1,500 Da, 80 to 750 Da, or 150 Da to 500 Da, and a number averaged functionality of 2 to 10, 2 to 6, 2 to 5, 3 to 5, or 3 to 4, such as where the rigid polyol is present in an amount of at least 80% by weight, at least 90% by weight, at least 95% by weight or at least 99% by weight, based on the total weight of polyol present in the polyurethane-forming reaction mixture.
Paragraph 19. The process of paragraph 18, wherein the rigid polyol comprises at least one amine-initiated, such as aliphatic amine-initiated, polyether polyol having a functionality of greater than 3, greater than 3 to 5, 4 to 5, or 4, and a molecular weight of 150 to 410 or 240 Da to 300 Da, such as where the amine-initiated polyether polyol is present in an amount of 10 to 50%, 20 to 40%, or 30 to 40% by weight, based upon the total weight of polyol in the polyurethane-forming reaction mixture.
Paragraph 20. The process of paragraph 18 or paragraph 19, wherein the rigid polyol comprises a hydroxy-initiated polyether polyol, such as where the rigid hydroxyl-initiated polyether polyol is present in an amount of 50% to 90% by weight, 60 to 80% by weight or 60 to 70% by weight, based on total weight of polyol in the polyurethane-forming reaction mixture, or where the rigid hydroxyl-initiated polyether polyol is utilized in an amount of 50% to 90% by weight, 70 to 90% by weight or 80 to 90% by weight, based on total weight of polyol in the polyurethane-forming reaction mixture.
Paragraph 21. The process of paragraph 20, wherein the rigid hydroxyl-initiated polyether polyol comprises a hydroxy-initiated polyether polyol having a functionality of at least 3 and less than 4, and a hydroxy-initiated polyether polyol having a functionality of at least 4, such as 4 to 5, such as where the rigid hydroxyl-initiated polyether polyol having a functionality of at least 4 and the hydroxy-initiated polyether polyol having a functionality of at least 3 and less than 4 are present in a relative weight ratio of at least 1:1, such as 1:1 to 3:1, 1.5:1 to 2.5:1, or 1.7:1 to 2:1.
Paragraph 22. The process of paragraph 20, wherein the rigid hydroxyl-initiated polyether polyol consists essentially of hydroxyl-initiated polyether polyols having a functionality of 3.
Paragraph 23. The process of one of paragraph 1 to paragraph 22, wherein the catalyst comprises an organic metal salt, such as potassium 2-ethyl hexanoate, potassium oleate, potassium acetate, potassium hydroxide, bismuth octoate, zinc neodecanoate, dibutyltin dilaurate, dibutyltin diacetate, dibutyltin dioleate, or a mixture of any two or more thereof.
Paragraph 24. The process of one of paragraph 1 to paragraph 23, wherein the catalyst comprises a chelated organometallic/metalorganic catalyst, such as where the organometallic/metalorganic catalyst comprises a ligand prepared from a β-diketone, such as a β-diketone of the formula:

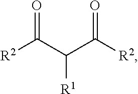

in which R¹ is hydrogen, an alkyl group having 1 to 10 carbon atoms, such as methyl, ethyl, propyl, isopropyl, butyl, isobutyl, t-butyl, pentyl, hexyl, cyclohexyl, heptyl, octyl, dodecanyl, octadecanyl, and the like, an aryl group, such as phenyl, cycloalkyl, or a hydroxyl, nitro, or cyano derivative thereof; and each R² is independently a hydrocarbon group, such as a saturated hydrocarbon group, such as methyl, ethyl, propyl, isopropyl, butyl, isobutyl, t-butyl, pentyl, hexyl, cyclohexyl, heptyl, octyl, dodecanyl, octadecanyl and the like, or an unsaturated hydrocarbon group, such as vinyl, an allyl, prenyl, crotyl, cyclopentadienyl, phenyl, tolyl, xylyl, a substituted aryl group and the like, or where the β-diketone comprises 2,4-pentanedione, 1,1,1-trifluoro-2,4-pentanedione, 1,1,1,5,5,5-hexafluoro-2,4-pentanedione, 2,4-hexanedione, 5-methyl-2,4-hexanedione, 5,5-dimethyl-2,4-hexanedione, 3-ethyl-2,4-pentanedione, 3-methyl-2,4-pentanedione, 2,4-octanedione, 2,4-decanedione, 2,2-dimethyl-3,5-nonanedione, 2,4-tridecanedione, 1-cyclohexyl-1,3-butanedione, 5,5-dimethyl-1,3-cyclohexanedione, 1,3-cyclohexanedione, 1-phenyl-1,3-butanedione, 1-phenyl-1,3-pentanedione, 1-(4-biphenyl)-1,3-butanedione, 3-benzyl-2,4-pentanedione, 1-phenyl-5,5-dimethyl-2,4-hexanedione, 1-phenyl-2-butyl-1,3-butanedione, and 1-phenyl-3,3-(2-methoxy-phenyl)-1,3-propanedione, or a mixture of any two or more thereof.
Paragraph 25. The process of paragraph 24, wherein the chelated organometallic/metalorganic catalyst comprises aluminum, barium, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, tin (II), tin (IV), titanium, vanadium, yttrium, zinc, zirconium, or a combination thereof.
Paragraph 26. The process of paragraph 24 or paragraph 25, wherein the organometallic/metalorganic catalyst comprises an organometallic/metalorganic catalyst having at least 3 ligand sites, such as where the organometallic/metalorganic catalyst comprises an organometallic catalyst having 2 ligand sites and an organometallic catalyst having 3 or more, in some cases 3, ligand sites.
Paragraph 27. The process of one of paragraph 24 to paragraph 26, wherein the organometallic/metalorganic catalyst comprises a dialkylmetal dicarboxylate and a monoalkylmetal tricarboxylate, such as (i) a catalyst of the formula (1) and (ii) a catalyst of formula (2), in which formula (1) is

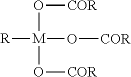

and formula (2) is

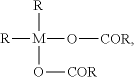

wherein M is tin (IV) and each R is independently a hydrocarbon or a substituted hydrocarbon radical, such as an alkyl, aralkyl, aryl, alkaryl, cycloalkyl, alkenyl, or cycloalkenyl radical.
Paragraph 28. The process of one of paragraph 24 to paragraph 27, wherein the organometallic/metalorganic catalyst comprises an organotin catalyst, such as an organotin (IV) catalyst, such as where the organometallic catalyst comprises both a dialkyltin dicarboxylate and a monoalkyltin tricarboxylate, such as where the dialkyltin dicarboxylate comprises dimethyltin dineodecanoate ((CH₃)₂Sn(OOCC₉H₁₉)₂), dibutyltin diacetate ((C₄H₉)₂Sn(OOCCH₃)₂), dibutyltin dilaurate ((C₄H₉)₂Sn(OOCC₁₁H₂₃)₂), dioctyltin diacetate ((C₈H₁₇)₂Sn(OOCCH₃)₂), dioctyltin di(2-ethylhexanoate) ((C₈H₁₇)₂Sn(OOCC₇H₁₅)₂), dioctyltin dilaurate ((C₈H₁₇)₂Sn(OOCC₁₁H₂₃)₂), dibutyltin dineodecanoate ((C₄H₉)₂Sn(OOCC₉H₁₉)₂) or a mixture of any two or more thereof, and the monoalkyltin tricarboxylate comprises monobutyltin trisoctoate, monobutyltin tris(2-ethylhexanoate), or a mixture of any two or more thereof.
Paragraph 29. The process of one of paragraph 24 to paragraph 28, wherein the organometallic/metalorganic catalyst comprises a dialkylmetal dicarboxylate, such as a dialkyltin dicarboxylate, and a monalkylmetal tricarboxylate, such as a monoalkyltin tricarboxylate, in which the monoalkylmetal tricarboxylate and the dialkylmetal dicarboxylate are present in a relative ratio, by weight, of 1:5 to 5:1, 1:3 to 3:1, 1:2 to 2:1, or 1:1.5 to 1.5:1.
Paragraph 30. The process of one of paragraph 24 to paragraph 29, wherein the chelating agent, such as the β-diketone, is present in an amount sufficient to bind with at least 80%, at least 90%, or 100% of the ligand sites of the organometallic/metalorganic catalyst present.
Paragraph 31. The process of one of paragraph 1 to paragraph 30, wherein catalyst is present in an amount of 0.1 to 3% by weight or 0.2 to 2.5% by weight, based on total weight of the polyurethane foam-forming reaction mixture.
Paragraph 32. The process of one of paragraph 1 to paragraph 31, wherein the cyclic carbonate ester comprises butylene carbonate, ethylene carbonate, propylene carbonate, glycerol carbonate, or a mixture of any two or more thereof.
Paragraph 33. The process of one of paragraph 1 to paragraph 32, wherein the cyclic carbonate ester is present in an amount of 0.1 to 5% by weight, 1 to 4% by weight, or 1.5 to 3% by weight, based on total weight of the polyurethane-forming reaction mixture.
Paragraph 34. The process of one of paragraph 1 to paragraph 33, wherein the polyurethane-forming reaction mixture has an index of 90 to 120% or 105 to 115%.
Paragraph 35. The process of one of paragraph 2 to paragraph 34, wherein the resin impregnator is a resin injection chamber that has a tubular cross-section, and the polyurethane-forming reaction mixture is injected from only one side of the resin injection chamber.
Paragraph 36. A fiber reinforced polyurethane composite produced by the process of one of paragraph 1 to paragraph 35.
Paragraph 37. A process for producing a fiber reinforced polyurethane composite comprising: (a) continuously pulling a roving or tow of continuous fiber reinforcing material through a resin injection chamber having a tubular cross-section; (b) contacting the continuous fiber reinforcing material with a polyurethane-forming reaction mixture in the resin injection chamber by injecting the polyurethane-forming reaction mixture from only one side of the resin injection chamber such that at least partial wetting of the continuous fiber reinforcing material by the polyurethane-forming reaction mixture occurs in the resin injection chamber; (c) directing the at least partially wetted fiber reinforcing material through a heating die that is heated to a reaction temperature sufficient to form the fiber reinforced polyurethane composite in the heating die; and (d) drawing the fiber reinforced polyurethane composite from the heating die, wherein the polyurethane-forming reaction mixture comprises: (i) a polyisocyanate; (ii) a polyol having functionality of greater than 1.8 to 10 and an OH number of 200 to 1200 mg KOH/g; (iii) a catalyst; and (iv) a cyclic carbonate ester.
Paragraph 38. The process of paragraph 37, wherein the conditions in the resin injection chamber are such that little or no polymerization of the polyurethane-forming reaction mixture occurs in the resin injection chamber.
Paragraph 39. The process of paragraph 37 or paragraph 38, wherein the continuous fiber reinforcing material comprises glass fiber, glass mat, carbon fiber, polyester fiber, natural fiber, aramid fiber, nylon fiber, basalt fiber, or a combination of any two or more thereof.
Paragraph 40. The process of one of paragraph 37 to paragraph 39, wherein the continuous fiber reinforcing material is present in an amount of 30 to 95% by weight, 40 to 90% by weight, 60 to 90% by weight, or 70 to 90% by weight, based on the weight of the fiber reinforced polyurethane composite.
Paragraph 41. The process of one of paragraph 37 to paragraph 40, wherein a polyisocyanate component and an isocyanate-reactive component are the only components fed into the resin impregnator.
Paragraph 42. The process of one of paragraph 37 to paragraph 41, wherein the polyisocyanate comprises an aromatic polyisocyanate, an aliphatic polyisocyanate, a cycloaliphatic polyisocyanate, or a combination of any two or more thereof, such as where the polyisocyanate has a viscosity at 25 °C of less than 1000 cps.
Paragraph 43. The process of one of paragraph 37 to paragraph 42, wherein the polyisocyanate is represented by the formula:

Q(NCO)ₙ

in which n is a number from 2 to 5, such as 2 to 3, and Q is an aliphatic hydrocarbon group containing 2 to 12, such as 4 to 6, carbon atoms, a cycloaliphatic hydrocarbon group containing 4 to 6, such as 5 to 6, carbon atoms, an araliphatic hydrocarbon group containing 8 to 15, such as 8 to 13, carbon atoms, or an aromatic hydrocarbon group containing 6 to 15, such as 6 to 13, carbon atoms.
Paragraph 44. The process of one of paragraph 37 to paragraph 43, wherein the polyisocyanate comprises ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of thereof; 1-isocyanato-3,3,5-trimethyl-5-isocyanatomethylcyclohexane (isophorone diisocyanate); 2,4- and 2,6-hexahydrotoluene diisocyanate and mixtures thereof; dicyclohexylmethane-4,4′-diisocyanate (hydrogenated MDI, or HMDI); 1,3- and 1,4-phenylene diisocyanate; 2,4- and 2,6-toluene diisocyanate and mixtures thereof (TDI); diphenylmethane-2,4′- and/or -4,4′-diisocyanate (MDI); naphthylene-1,5-diisocyanate; triphenylmethane-4,4′,4″-triisocyanate; a polyphenyl-polymethylene-polyisocyanate; a norbornane diisocyanate; m- and p-isocyanatophenyl sulfonylisocyanates; perchlorinated aryl polyisocyanates; a modified polyisocyanate containing carbodiimide groups; a modified polyisocyanate containing urethane groups; a modified polyisocyanates containing allophanate groups; a modified polyisocyanate containing isocyanurate groups; a modified polyisocyanate containing urea groups; a polyisocyanate containing biuret groups; a polyisocyanate obtained by a telomerization reaction; a polyisocyanate containing ester groups; or a mixture of any two or more thereof.
Paragraph 45. The process of one of paragraph 37 to paragraph 44, wherein the polyisocyanate comprises an aliphatic polyisocyanate present in an amount of at least 50% by weight, such as at least 80% by weight, at least 90% by weight, or, in some cases at least 99% by weight or 100% by weight, based on the total weight of polyisocyanate, such as where the aliphatic polyisocyanate comprises ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures thereof; 1-isocyanato-3,3,5-trimethyl-5-isocyanatomethylcyclohexane (isophorone diisocyanate or IPDI); dicyclohexylmethane-4,4′-diisocyanate (hydrogenated MDI, or HMDI), or a mixture of any two or more thereof.
Paragraph 46. The process of one of paragraph 37 to paragraph 45, wherein the polyisocyanate component has a free isocyanate group content of 20% to 30% by weight, 23% to 30%, or 25% to 27% by weight, such as where the polyisocyanate comprises a HMDI-terminated polyether prepolymer, such as those based on polypropylene ether glycol, that has a NCO content of 20% to 30% by weight, 23% to 30%, or 25% to 27% by weight.
Paragraph 47. The process of one of paragraph 37 to paragraph 46, wherein the polyurethane-forming reaction mixture further comprises a natural oil polyol having a functionality of 1.0 to 1.8 and an OH number of 20 to 200 mg KOH/g, such as where the natural oil polyol has a functionality of 1.0 to 1.5, 1.1 to 1.4 or 1.2 to 1.4 and/or an OH number of 20 to 100 mg KOH/g, 50 to 100 mg KOH/g, or 60 to 80 mg KOH/g.
Paragraph 48. The process of paragraph 47, wherein the natural oil polyol is derived from castor oil, peanut oil, soybean oil, canola oil, or a mixture of any two or more thereof.
Paragraph 49. The process of paragraph 47 or paragraph 48, wherein the natural oil polyol is present in an amount of 0.2 to 8% by weight, 1 to 8% by weight, 2 to 6% by weight, or 3 to 5% by weight, based on total weight of the polyurethane-forming reaction mixture.
Paragraph 50. The process of one of paragraph 37 to paragraph 49, wherein the polyol having functionality of greater than 1.8 to 10 and an OH number of 200 to 1200 mg KOH/g comprises a polyether polyol, polyester polyol, or a mixture thereof.
Paragraph 51. The process of one of paragraph 37 to paragraph 50, wherein the polyol having a functionality of greater than 1.8 to 10 and an OH number of 200 to 1200 mg KOH/g has a functionality of 2 to 6 or 3 to 4.
Paragraph 52. The process of one of paragraph 37 to paragraph 51, wherein the polyol having functionality of greater than 1.8 to 10 and an OH number of 200 to 1200 mg KOH/g comprises a rigid polyol having a number averaged molecular weight of 80 Da to less than 1,500 Da, 80 to 750 Da, or 150 Da to 500 Da, and a number averaged functionality of 2 to 10, 2 to 6, 2 to 5, 3 to 5, or 3 to 4, such as where the rigid polyol is present in an amount of at least 80% by weight, at least 90% by weight, at least 95% by weight or at least 99% by weight, based on the total weight of polyol present in the polyurethane-forming reaction mixture.
Paragraph 53. The process of paragraph 52, wherein the rigid polyol comprises at least one amine-initiated, such as aliphatic amine-initiated, polyether polyol having a functionality of greater than 3, greater than 3 to 5, 4 to 5, or 4, and a molecular weight of 150 to 410 or 240 Da to 300 Da, such as where the amine-initiated polyether polyol is present in an amount of 10 to 50%, 20 to 40%, or 30 to 40% by weight, based upon the total weight of polyol in the polyurethane-forming reaction mixture.
Paragraph 54. The process of paragraph 53 or paragraph 54, wherein the rigid polyol comprises a hydroxy-initiated polyether polyol, such as where the rigid hydroxyl-initiated polyether polyol is present in an amount of 50% to 90% by weight, 60 to 80% by weight or 60 to 70% by weight, based on total weight of polyol in the polyurethane-forming reaction mixture, or where the rigid hydroxyl-initiated polyether polyol is utilized in an amount of 50% to 90% by weight, 70 to 90% by weight or 80 to 90% by weight, based on total weight of polyol in the polyurethane-forming reaction mixture.
Paragraph 55. The process of paragraph 54, wherein the rigid hydroxyl-initiated polyether polyol comprises a hydroxy-initiated polyether polyol having a functionality of at least 3 and less than 4, and a hydroxy-initiated polyether polyol having a functionality of at least 4, such as 4 to 5, such as where the rigid hydroxyl-initiated polyether polyol having a functionality of at least 4 and the hydroxy-initiated polyether polyol having a functionality of at least 3 and less than 4 are present in a relative weight ratio of at least 1:1, such as 1:1 to 3:1, 1.5:1 to 2.5:1, or 1.7:1 to 2:1.
Paragraph 56. The process of paragraph 54, wherein the rigid hydroxyl-initiated polyether polyol consists essentially of hydroxyl-initiated polyether polyols having a functionality of 3.
Paragraph 57. The process of one of paragraph 37 to paragraph 56, wherein the catalyst comprises an organic metal salt, such as potassium 2-ethyl hexanoate, potassium oleate, potassium acetate, potassium hydroxide, bismuth octoate, zinc neodecanoate, dibutyltin dilaurate, dibutyltin diacetate, dibutyltin dioleate, or a mixture of any two or more thereof.
Paragraph 58. The process of one of paragraph 37 to paragraph 57, wherein the catalyst comprises a chelated organometallic/metalorganic catalyst, such as where the organometallic/metalorganic catalyst comprises a ligand prepared from a β-diketone, such as a β-diketone of the formula:

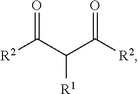

in which R¹ is hydrogen, an alkyl group having 1 to 10 carbon atoms, such as methyl, ethyl, propyl, isopropyl, butyl, isobutyl, t-butyl, pentyl, hexyl, cyclohexyl, heptyl, octyl, dodecanyl, octadecanyl, and the like, an aryl group, such as phenyl, cycloalkyl, or a hydroxyl, nitro, or cyano derivative thereof; and each R² is independently a hydrocarbon group, such as a saturated hydrocarbon group, such as methyl, ethyl, propyl, isopropyl, butyl, isobutyl, t-butyl, pentyl, hexyl, cyclohexyl, heptyl, octyl, dodecanyl, octadecanyl and the like, or an unsaturated hydrocarbon group, such as vinyl, an allyl, prenyl, crotyl, cyclopentadienyl, phenyl, tolyl, xylyl, a substituted aryl group and the like, or where the β-diketone comprises 2,4-pentanedione, 1,1,1-trifluoro-2,4-pentanedione, 1,1,1,5,5,5-hexafluoro-2,4-pentanedione, 2,4-hexanedione, 5-methyl-2,4-hexanedione, 5,5-dimethyl-2,4-hexanedione, 3-ethyl-2,4-pentanedione, 3-methyl-2,4-pentanedione, 2,4-octanedione, 2,4-decanedione, 2,2-dimethyl-3,5-nonanedione, 2,4-tridecanedione, 1-cyclohexyl-1,3-butanedione, 5,5-dimethyl-1,3-cyclohexanedione, 1,3-cyclohexanedione, 1-phenyl-1,3-butanedione, 1-phenyl-1,3-pentanedione, 1-(4-biphenyl)-1,3-butanedione, 3-benzyl-2,4-pentanedione, 1-phenyl-5,5-dimethyl-2,4-hexanedione, 1-phenyl-2-butyl-1,3-butanedione, and 1-phenyl-3,3-(2-methoxy-phenyl)-1,3-propanedione, or a mixture of any two or more thereof.
Paragraph 59. The process of paragraph 58, wherein the chelated organometallic/metalorganic catalyst comprises aluminum, barium, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, tin (II), tin (IV), titanium, vanadium, yttrium, zinc, zirconium, or a combination thereof.
Paragraph 60. The process of paragraph 57 or paragraph 58, wherein the organometallic/metalorganic catalyst comprises an organometallic/metalorganic catalyst having at least 3 ligand sites, such as where the organometallic/metalorganic catalyst comprises an organometallic catalyst having 2 ligand sites and an organometallic catalyst having 3 or more, in some cases 3, ligand sites.
Paragraph 61. The process of one of paragraph 57 to paragraph 60, wherein the organometallic/metalorganic catalyst comprises a dialkylmetal dicarboxylate and a monoalkylmetal tricarboxylate, such as (i) a catalyst of the formula (1) and (ii) a catalyst of formula (2), in which formula (1) is

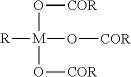

and formula (2) is

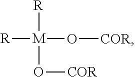

wherein M is tin (IV) and each R is independently a hydrocarbon or a substituted hydrocarbon radical, such as an alkyl, aralkyl, aryl, alkaryl, cycloalkyl, alkenyl, or cycloalkenyl radical.
Paragraph 62. The process of one of paragraph 57 to paragraph 61, wherein the organometallic/metalorganic catalyst comprises an organotin catalyst, such as an organotin (IV) catalyst, such as where the organometallic catalyst comprises both a dialkyltin dicarboxylate and a monoalkyltin tricarboxylate, such as where the dialkyltin dicarboxylate comprises dimethyltin dineodecanoate ((CH₃)₂Sn(OOCC₉H₁₉)₂), dibutyltin diacetate ((C₄H₉)₂Sn(OOCCH₃)₂), dibutyltin dilaurate ((C₄H₉)₂Sn(OOCC₁₁H₂₃)₂), dioctyltin diacetate ((C₈H₁₇)₂Sn(OOCCH₃)₂), dioctyltin di(2-ethylhexanoate) ((C₈H₁₇)₂Sn(OOCC₇H₁₅)₂), dioctyltin dilaurate ((C₈H₁₇)₂Sn(OOCC₁₁H₂₃)₂), dibutyltin dineodecanoate ((C₄H₉)₂Sn(OOCC₉H₁₉)₂) or a mixture of any two or more thereof, and the monoalkyltin tricarboxylate comprises monobutyltin trisoctoate, monobutyltin tris(2-ethylhexanoate), or a mixture of any two or more thereof.
Paragraph 63. The process of one of paragraph 57 to paragraph 62, wherein the organometallic/metalorganic catalyst comprises a dialkylmetal dicarboxylate, such as a dialkyltin dicarboxylate, and a monalkylmetal tricarboxylate, such as a monoalkyltin tricarboxylate, in which the monoalkylmetal tricarboxylate and the dialkylmetal dicarboxylate are present in a relative ratio, by weight, of 1:5 to 5:1, 1:3 to 3:1, 1:2 to 2:1, or 1:1.5 to 1.5:1.
Paragraph 64. The process of one of paragraph 57 to paragraph 63, wherein the chelating agent, such as the β-diketone, is present in an amount sufficient to bind with at least 80%, at least 90%, or 100% of the ligand sites of the organometallic/metalorganic catalyst present.
Paragraph 65. The process of one of paragraph 37 to paragraph 64, wherein catalyst is present in an amount of 0.1 to 3% by weight or 0.2 to 2.5% by weight, based on total weight of the polyurethane foam-forming reaction mixture.
Paragraph 66. The process of one of paragraph 37 to paragraph 65, wherein the cyclic carbonate ester comprises butylene carbonate, ethylene carbonate, propylene carbonate, glycerol carbonate, or a mixture of any two or more thereof.
Paragraph 67. The process of one of paragraph 37 to paragraph 66, wherein the cyclic carbonate ester is present in an amount of 0.1 to 5% by weight, 1 to 4% by weight, or 1.5 to 3% by weight, based on total weight of the polyurethane-forming reaction mixture.
Paragraph 68. The process of one of paragraph 37 to paragraph 67, wherein the polyurethane-forming reaction mixture has an index of 90 to 120% or 105 to 115%.
Paragraph 69. A fiber reinforced polyurethane composite produced by the process of one of paragraph 37 to paragraph 68.

The non-limiting and non-exhaustive examples that follow are intended to further describe various non-limiting and non-exhaustive implementations without restricting the scope of the implementations described in this specification.

### EXAMPLES

The following components were used in the Examples set forth in the tables below. Amounts listed are in parts by weight.
POLYOL A: An ethylenediamine initiated polyether polyol having a functionality of 4.0 and a hydroxyl number of 770 mg KOH/g;
POLYOL B: A glycerin initiated polypropylene oxide-based triol having a hydroxyl number of 1050 mg KOH/g;
POLYOL C: A pentaerythritol-based, tetra-functional polyether polyol having a hydroxyl number of 555 mg KOH/g;
POLYOL D: A glycerin initiated propylene oxide-based triol having a hydroxyl number of 470 mg KOH/g;
POLYOL E: A glycerin initiated propylene oxide-based polyether triol with a hydroxyl number of 240 mg KOH/g;
POLYOL F: A glycerin initiated ethylene oxide-capped triol with a hydroxyl number of 36 mg KOH/g;
NOP: A 1.3 functional soy-based polyol having a hydroxyl number of 70 mg KOH/g commercially available from Cargill as BiOH® 6205;
UV STABILIZER/ANTIOXIDANT BLEND: A liquid heat and light stabilizer blends containing a benzotriazole-based UV absorber, a basic HALS as well as a phenolic antioxidant Commercially available from BASF as Tinuvin® B75;
UV STABILIZER: Commercially available from Chromaflo Technologies Corp. as SYNERMIX™ 77-90495;
INTERNAL MOLD RELEASE: Commercially available from Axel Plastics as MoldWiz® INT-1968RAC;
MOISTURE SCAVENGER: A dispersion of a Zeolite powder in a polyol, UOP-L Powder from Honeywell;
DELAYED-ACTION CATALYST 1: An organotin catalyst mixture of dibutyltin dilaurate and acetylacetone, with an amount of acetylacetone sufficient to bind with 100% of the ligand sites of the dibutyltin dilaurate and the monobutyltin carboxylate of CATALYST 1;
DELAYED-ACTION CATALYST 2: A delayed-action dibuyltin mercaptide catalyst commercially available from Galata Chemicals as Fomrez UL-6; CATALYST 1: A monobutyltin carboxylate catalyst available from Reaxis Inc. as REAXIS® C220;
CATALYST 2: A dibutyltin dilaurate catalyst available from Evonik as Dabco® T 12;
CYCLIC CARBONATE ESTER: Propylene carbonate; ALIPHATIC DIOL: Ethylene glycol;
H₁₂MDI PREPOLYMER: A polyfunctional aliphatic polyisocyanate having an NCO content of 26% which is commercially available from Covestro LLC as Baytec WP260; and
PMDI: polymeric diphenylmethane-diisocyanate (pMDI) with a moderately high 2,4′-MDI isomer content having an NCO content of 31.8-32.6 wt % and a viscosity of about 40 mPa·s at 25 °C.

The composites produced in the examples which follow were produced by several commercial pultruders in the following manner: Complex Pack¹ represents a flat profile with dimensions of 23×0.635 cm containing a mixture of Type 30, 4400 TEX rovings, 2-ounce mats, triaxial fabrics and stitched veils. Glass loadings were approximately 72% by weight. The Roving Only² profile was a complex geometric shape containing only Type 30, 4400 TEX rovings to an 80% glass loading by weight. The Roving Only³ profile was a larger complex geometric shape containing Type 30, 4400 TEX rovings at an 80% glass loading by weight. All profiles were pultruded with a resin injection chamber in front of the die and three zones of platen heat set between 350-420 °F to cure the composite. Results are set forth in the tables below:

TABLE 1

| Component | Comparative A | System 3 | System 2 | System 3 |
|---|---|---|---|---|
| Polyol A. | 9.76 | 8.70 | 9.58 | 9.11 |
| Polyol B | 7.01 | 6.25 | 6.88 | 6.54 |
| Polyol C | 12.65 | 11.28 | 12.42 | 11.81 |
| NOP | — | — | — | 2.8 |
| UV Stabilizer / Antioxidant Blend | 0.93 | 0.83 | 0.92 | 0.96 |
| UV Stabilizer | 0.93 | 0.83 | 0.92 | 0.96 |
| Internal mold release | 1.20 | 1.07 | 1.17 | 1.10 |
| Moisture scavenger | 0.63 | 0.56 | 0.62 | 0.65 |
| Delayed-action catalyst 1 | 0.84 | 0.75 | 0.83 | 0.86 |
| Catalyst 1 | 1.01 | 0.90 | 0.99 | 1.03 |
| Catalyst 2 | 0.09 | 0.08 | 0.09 | 0.09 |
| Cyclic Carbonate Ester | — | — | 1.81 | 1.89 |
| Aliphatic Diol | — | 1.64 | — | — |
| H12MDI Prepolymer | 64.95 | 67.11 | 63.77 | 62.17 |
| Mix Ratio (Isocyanate / Polyol) | 185/100 | 204/100 | 176/100 | 164/100 |
| Viscosity a 25 °C Polyol only (cps) | 4,000 | 2,650 | 2,230 | 2,080 |
| Viscosity at 25 °C Polyol + Iso (cps) | 1,660 | 1,047 | 969 | 948 |
| Ultimate Pull Speed (in./min.) - Complex pack ¹ | 12 | 18 | 22 | *** |
| Ultimate Pull Speed (in./min.) - Roving only ² | 23 | ••• | 40 | *** |
| Tg (°C) ² | 122 | ••• | 122 | *** |
| Surface Appearance | + | + | ++ | *** |
| Short Beam Shear - Perpendicular (psi) ¹ | 5,281 | 4,766 | 5,324 | *** |
| Short Beam Shear - Parallel (psi) ¹ | 5,638 | 5,893 | 5,556 | *** |

Note:
Asterisks denote trial testing results pending. Black dots indicate system not trialed in roving only profiles.
“++” indicates a glossier surface appearance with fewer imperfections relative to surface appearance “+”.
Ultimate Pull Speed denotes the fastest line speed achieved with no significant loss of properties or appearance quality.

TABLE 2

| Component | Comparative | System 1 |
|---|---|---|
| Polyol B | 11.24 | 10.97 |
| Polyol D | 11.24 | 10.97 |
| Polyol E | 12.86 | 12.55 |
| Polyol F | 4.28 | 4.18 |
| NOP | 4.07 | 3.99 |
| Delayed-action catalyst 2 | 0.25 | 0.25 |
| Moisture scavenger | 1.07 | 1.04 |
| Internal mold release | 1.35 | 1.30 |
| Cyclic Carbonate Ester | — | 2.38 |
| PMDI | 53.64 | 52.36 |
| Mix Ratio (Isocyanate / Polyol) | 116/100 | 110/100 |
| Viscosity at 25 °C Polyol only (eps) | 1,200 | 560 |
| Viscosity at 25 °C Polyol + Iso (cps) | 585 | 290 |
| Surface Appearance | + | ++ |
| Ultimate Pull Speed (in./min.) - Roving only ³ | 24 | 42 |

Note:
Ultimate Pull Speed denotes the fastest line speed able to achieved with no significant loss of properties or appearance quality.
“++” indicates a glossier surface appearance with fewer imperfections relative to surface appearance “+”.

As is apparent in TABLE 1, System 1 produced a 50% line-speed improvement over the Comparative A system with an equivalent surface appearance. Beyond that speed threshold, a loss of surface quality and properties could be observed. System 2 produced 74-83% line-speed improvements with no significant degradation of physical properties and imparting a glossier surface quality with fewer noticeable surface imperfections.

As is apparent in TABLE 2, 75% line-speed improvements were achieved with higher surface quality improvements as well as the new ability to achieve a complete glass wet-out by injecting several large tubular profiles with complex glass packs from one-side only. This was not previously possible with the Comparative system at a slurry viscosity of 585 cps. It is currently hypothesized that these additional surface quality and glass wetting benefits are due to a synergistic effect between the non-reactive cyclic carbonate ester and the natural oil polyol. System 3 in TABLE 1 represents a blend of these two materials in an aliphatic system.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for producing a fiber reinforced polyurethane composite, comprising:
(a) continuously pulling a roving or tow of continuous fiber reinforcing material through a resin injection chamber;
(b) contacting the continuous fiber reinforcing material with a polyurethane-forming reaction mixture in the resin injection chamber such that at least partial wetting of the continuous fiber reinforcing material by the polyurethane-forming reaction mixture occurs in the resin injection chamber;
(c) directing the at least partially wetted fiber reinforcing material through a heating die that is heated to a reaction temperature sufficient to form the fiber reinforced polyurethane composite in the heating die; and
(d) drawing the fiber reinforced polyurethane composite from the heating die,
wherein the polyurethane-forming reaction mixture comprises:
(i) a polyisocyanate;
(ii) a natural oil polyol having a functionality of 1.0 to 1.8 and an OH number of 20 to 200 mg KOH/g;
(iii) a polyol having functionality of greater than 1.8 to 10 and an OH number of 200 to 1200 mg KOH/g;
(iv) a catalyst; and
(v) a cyclic carbonate ester.

2. The process of claim 1, wherein the natural oil polyol has a functionality of 1.0 to 1.5 and an OH number of 50 to 100 mg KOH/g.

3. The process of claim 1, wherein natural oil polyol is present in an amount of 0.2 to 5% by weight, based on total weight of the polyurethane-forming reaction mixture.

4. The process of claim 3, wherein natural oil polyol is present in an amount of 3 to 5% by weight, based on total weight of the polyurethane-forming reaction mixture.

5. The process of claim 1, wherein the polyol having functionality of greater than 1.8 to 10 and an OH number of 200 to 1200 mg KOH/g comprises an aliphatic amine-initiated polyether polyol having a functionality of greater than 3 to 5 and a molecular weight of 150 to 410 Da.

6. The process of claim 5, wherein aliphatic amine-initiated polyether polyol having a functionality of greater than 3 to 5 and a molecular weight of 150 to 410 Da is present in an amount of 10 to 50% by weight, based upon total weight of polyol in the polyurethane-forming reaction mixture.

7. The process of claim 1, wherein the polyol having functionality of greater than 1.8 to 10 and an OH number of 200 to 1200 mg KOH/g comprises a hydroxy-initiated polyether polyol having a functionality of at least 3 and less than 4 and a hydroxy-initiated polyether polyol having a functionality of at least 4, wherein the hydroxyl-initiated polyether polyol having a functionality of at least 4 and the hydroxy-initiated polyether polyol having a functionality of at least 3 and less than 4 are present in a relative weight ratio of 1:1 to 3:1.

8. The process of claim 1, wherein the cyclic carbonate ester is present in an amount of 0.1 to 5% by weight, based on total weight of the polyurethane-forming reaction mixture.

9. The process of claim 8, wherein the cyclic carbonate ester is present in an amount of 1 to 4% by weight, based on total weight of the polyurethane-forming reaction mixture.

10. A process for producing a fiber reinforced polyurethane composite, comprising:
(a) continuously pulling a roving or tow of continuous fiber reinforcing material through a resin injection chamber having a tubular cross-section;
(b) contacting the continuous fiber reinforcing material with a polyurethane-forming reaction mixture in the resin injection chamber by injecting the polyurethane-forming reaction mixture from only one side of the resin injection chamber such that at least partial wetting of the continuous fiber reinforcing material by the polyurethane-forming reaction mixture occurs in the resin injection chamber;
(c) directing the at least partially wetted fiber reinforcing material through a heating die that is heated to a reaction temperature sufficient to form the fiber reinforced polyurethane composite in the heating die; and
(d) drawing the fiber reinforced polyurethane composite from the heating die,
wherein the polyurethane-forming reaction mixture comprises:
(i) a polyisocyanate;
(ii) a polyol having functionality of greater than 1.8 to 10 and an OH number of 200 to 1200 mg KOH/g;
(iii) a catalyst; and
(iv) a cyclic carbonate ester.

11. The process of claim 10, wherein the polyurethane-forming reaction mixture further comprises a natural oil polyol having a functionality of 1.0 to 1.8 and an OH number of 20 to 200 mg KOH/g.

12. The process of claim 11, wherein the natural oil polyol has a functionality of 1.0 to 1.5 and an OH number of 50 to 100 mg KOH/g.

13. The process of claim 11, wherein natural oil polyol is present in an amount of 0.2 to 5% by weight, based on total weight of the polyurethane-forming reaction mixture.

14. The process of claim 13, wherein natural oil polyol is present in an amount of 3 to 5% by weight, based on total weight of the polyurethane-forming reaction mixture.

15. The process of claim 10, wherein the polyol having functionality of greater than 1.8 to 10 and an OH number of 200 to 1200 mg KOH/g comprises an aliphatic amine-initiated polyether polyol having a functionality of greater than 3 to 5 and a molecular weight of 150 to 410 Da.

16. The process of claim 15, wherein aliphatic amine-initiated polyether polyol having a functionality of greater than 3 to 5 and a molecular weight of 150 to 410 Da is present in an amount of 10 to 50% by weight, based upon total weight of polyol in the polyurethane-forming reaction mixture.

17. The process of claim 10, wherein the polyol having functionality of greater than 1.8 to 10 and an OH number of 200 to 1200 mg KOH/g comprises a hydroxy-initiated polyether polyol having a functionality of at least 3 and less than 4 and a hydroxy-initiated polyether polyol having a functionality of at least 4, wherein the hydroxyl-initiated polyether polyol having a functionality of at least 4 and the hydroxy-initiated polyether polyol having a functionality of at least 3 and less than 4 are present in a relative weight ratio of 1:1 to 3:1.

18. The process of claim 10, wherein the cyclic carbonate ester is present in an amount of 0.1 to 5% by weight, based on total weight of the polyurethane-forming reaction mixture.

19. The process of claim 18, wherein the cyclic carbonate ester is present in an amount of 1 to 4% by weight, based on total weight of the polyurethane-forming reaction mixture.
